(19) United States
(12) Patent Application Publication
(10) Pub. No.: US 2013/0151900 A1
(43) Pub. Date: Jun. 13, 2013

(54) DEBUG SYSTEM AND METHOD

(71) Applicant: KANG-BIN WANG, Shenzhen City (CN)

(72) Inventor: KANG-BIN WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/592,487

(22) Filed: Aug. 23, 2012

(30) Foreign Application Priority Data
Dec. 12, 2011 (CN) 201110411729.4

(51) Int. Cl. G06F 11/28

(52) U.S. Cl. 714/27; 714/E11.178

(57) ABSTRACT

A debug system includes a debug device and a computer. The debug device includes an SPI reading and writing module, a first control module, a detecting module, and a signal receiving and transmitting module. The computer includes a second control module and a display module. The SPI reading and writing module is connected to an SPI device. The second control module sends an inputted write command to the first control module. The first control module writes data to the SPI device according to the inputted write command. The detecting module sends a fail signal to the first control module after detecting that the data is not written to the SPI device and a written times of the data is greater than a predetermined times. The first control module sends the fail signal to the second control module. The second control module displays the fail signal on the display module.

### BACKGROUND

1. Technical Field

The present disclosure relates to debug systems and debug methods, and particularly to a debug system and a method based on a serial peripheral interface (SPI) bus.

2. Description of Related Art

Common debugging methods analyze data from the SPI bus via an oscillograph or logic analyzer. However, the need to connect to a peripheral device to input commands to read or write data is inconvenient. Therefore, there is a need for an improved debug system and method.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of one embodiment of a debug system.

FIG. 2 is flowchart of one embodiment of a writing data method of a debug method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or Assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

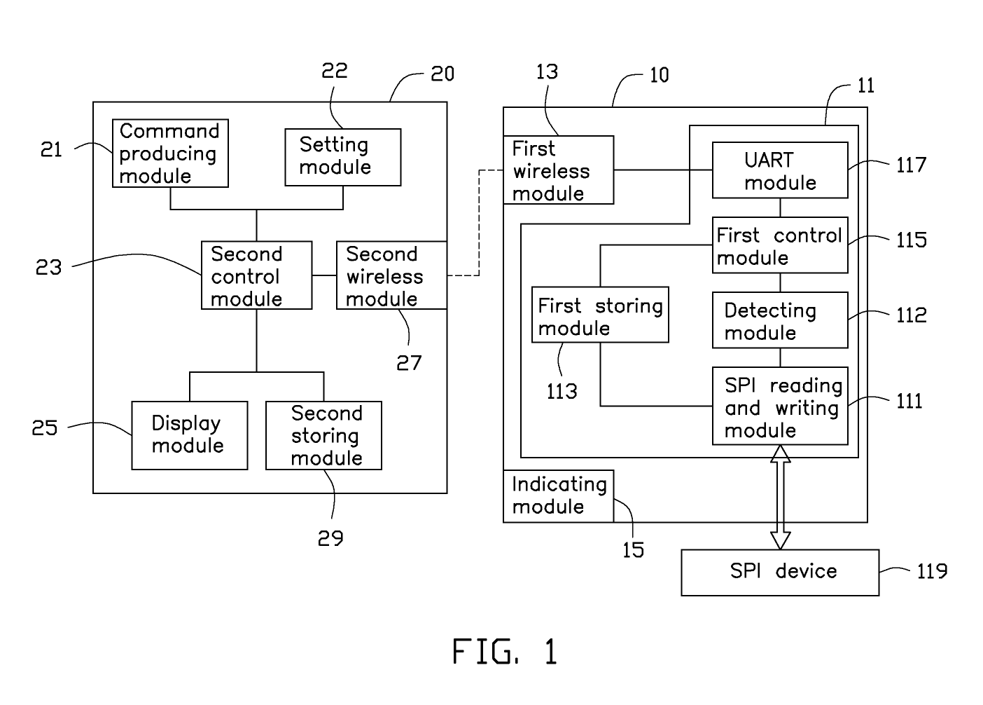

Referring to FIG. 1, a debug system according to one embodiment includes a debug device 10 and a computer 20.

The debug device 10 includes a control chip 11, a detecting module 112, a first wireless module 13 connected to the control chip 11, and an indicator module 15 connected to the control chip 11. In one embodiment, the control chip 11 is a micro control unit, and the first wireless module 13 is a PRT200 IC chip. The indicator module 15 is a light-emitting diode. The indicator module 15 indicates the work status of the control chip 11.

The control chip 11 includes an SPI reading and writing module 111, a first storing module 113, a first control module 115, and a signal receiving and sending module. In one embodiment, the signal receiving and sending module is a universal asynchronous receiver and transmitter (UART) module 117. The first storing module 113 is a random access memory. The SPI reading and writing module 111 is connected to an SPI device 119, such as a read-only memory.

The computer 20 includes a command producing module 21, a setting module 22, a second control module 23, a display module 25, a second wireless module 27, and a second storing module 29. In one embodiment, the second control module 23 is a central processing unit. The display module 25 is liquid crystal display. The second storing module 29 is a hard disk drive. There are wireless signals transmitted between the second wireless module 27 and the first wireless module 13. The user can input a read or write command to the command producing module 21 via an input device, such as a keyboard. The read command includes a reading code and a SPI address corresponding to the SPI device 119. The write command includes a writing code, a SPI address corresponding to the SPI device 119, and writing data. The user sets data transmitting speed of the UART module 117 via the setting module 22.

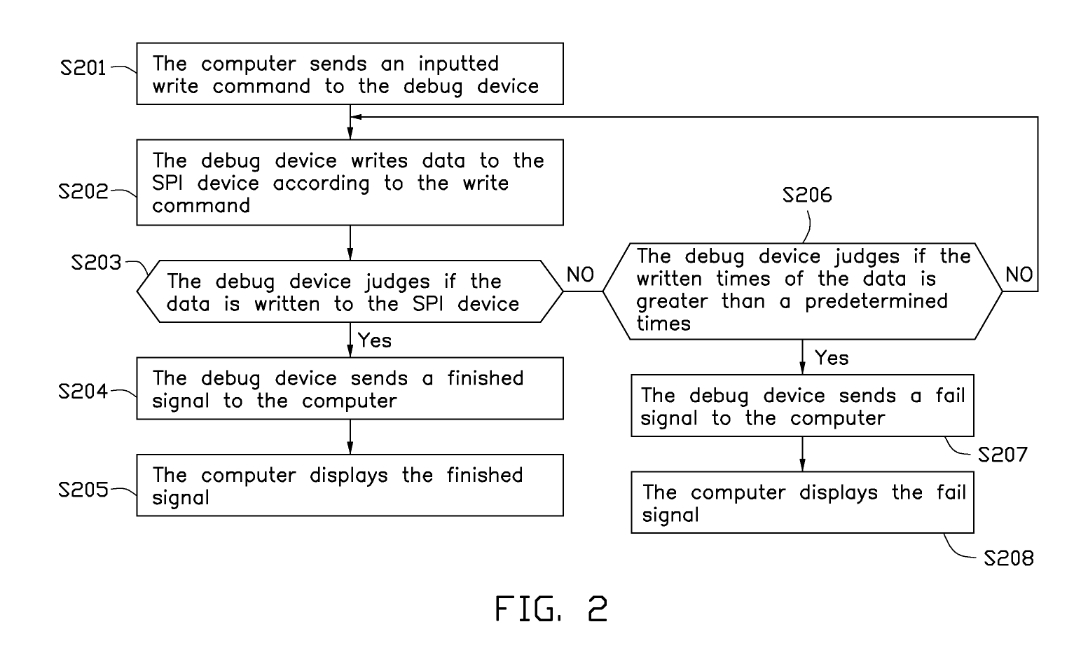

Referring to FIGS. 1 and 2, a writing data method of a debug method according to one embodiment is shown in the following steps.

S201, the computer 20 sends a write command to the first wireless module 13 via the second wireless module 27 after the data transmitting speed of the UART module 117 is set. The first wireless module 13 transmits the write command to the first control module 115 via the UART module 117.

S202, the first control module 115 of the debug device 10 writes writing data of the write command to the SPI device 119 via the SPI reading and writing module 111.

S203, the detecting module 112 of the debug device 10 determines if the writing data is written to the SPI device 119. If so, the process turns to step S204, if not, the process turns to step S206.

S204, the SPI reading and writing module 111 sends a finished signal to the first control module 115 after the writing data is written to the SPI device 119. The first control module 115 sends the finished signal to the second control module 23 via the UART module 117, the first wireless module 13 and the second wireless module 27.

S205, the second control module 23 displays the finished signal on the display module 25.

S206, the detecting module 112 determines if the written times of the writing data is greater than a predetermined times. If so, the process turns to step S207, If not, the process turns back to step S202.

S207, the SPI reading and writing module 111 sends a fail signal to the first control module 115 after the writing data is written to the SPI device 119. The first control module 115 sends the finished signal to the second control module 23 via the UART module 117, the first wireless module 13 and the second wireless module 27.

S208, the second control module 23 displays the fail signal on the display module 25.

It is to be understood, however, that even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A debug system comprising:
a debug device, the debug device comprising:
an SPI reading and writing module, the SPI reading and writing module being configured to be connected to an SPI device;
a first control module;
a signal receiving and transmitting module; and
a detecting module; and
a computer, the computer comprising a second control module and a display module;
wherein the second control module is configured to send an inputted write command to the first control module via the signal receiving and transmitting module; the first control module is configured to, according to the inputted write command, write data to the SPI device via the SPI reading and writing module; the detecting module is configured to send a fail signal to the first control module when detecting that the data is not written to the SPI device and that a written times of the data is greater than a predetermined times; and the first control module is configured to send the fail signal to the second control module via the signal receiving and transmitting module; and the second control module is further configured to display the fail signal on the display module.

2. The debug system of claim 1, wherein the detecting module is further configured to send a finished signal to the first control module when detecting that the data is written to the SPI device; the first control module is further configured to send the finished signal to the second control module via the signal receiving and transmitting module; and the second control module is further configured to display the finished signal on the display module.

3. The debug system of claim 1, wherein the debug device comprises a control chip, the SPI reading and writing module, the first control module and the signal receiving and transmitting module are defined in the control chip.

4. The debug system of claim 3, wherein the control chip is a micro control unit.

5. The debug system of claim 1, wherein the debug device further comprises a first wireless module connected to the signal receiving and transmitting module; the computer further comprises a second wireless module connected to the second control module; and the debug system is configured to transmit the inputted write command from the second control module to the first control module via the second wireless module, the first wireless module, and the signal receiving and transmitting module.

6. A debug method comprising:
inputting a write command to a debug device by a computer;
writing data corresponding to the write command to an SPI device connected to the debug device by the debug device;
if a written times of the data is greater than a predetermined times and the data is not written to the SPI device, sending a fail signal to the computer by the debug device; and
displaying the fail signal by the computer.

7. The debug method of claim 6, further comprising sending a finished signal to the computer by the debug device when the data is written to the SPI device and displaying the finished signal by the computer.

8. The debug method of claim 6, wherein the step of writing data comprises writing the data to the SPI device by a micro control unit of the debug device.

9. The debug method of claim 8, further comprising indicating a work status of the micro control unit by an light-emitting diode.
